(19) United States
(12) Patent Application Publication
(10) Pub. No.: US 2010/0082479 A1
(43) Pub. Date: Apr. 1, 2010

(54) Proxy-based payment system for portable objects

(75) Inventors: George William Erhart, Loveland, CO (US); Valentine C. Matula, Granville, OH (US); David Joseph Skiba, Golden, CO (US)

Correspondence Address: Avaya;DEMONT & BREYER, LLC, 100 COMMONS WAY, STE 250, HOLMDEL, NJ, 07733, US

(73) Assignee: Avaya Inc., Basking Ridge, NJ (US)

(21) Appl. No.: 12/242,005

(22) Filed: Sep. 30, 2008

(51) Int. Cl. G06Q 40/00

(52) U.S. Cl. 705/40

(57) ABSTRACT

A system is disclosed that features a transport vehicle that carries responsive objects, such as a truck hauling cargo units, in which the objects are equipped to provide payment information when queried. The transport vehicle is outfitted with a proxy that represents the responsive objects. The proxy is configured such that it is better able than the responsive objects to receive payment request signals from a querying device. The vehicle is also outfitted with i) sensors that detect the responsive objects and ii) sensors that detect state information of the vehicle, in which both sets of sensors provide information to the proxy. The object sensors are able to query each responsive object in the same way as the querying device would query those objects in the prior art. The proxy then responds to the query on behalf of the responsive objects.

### FIELD OF THE INVENTION

The present invention relates to telecommunications in general, and, more particularly, to providing a mechanism for billing and payment in the presence of one or more portable objects, such as a cargo unit.

### BACKGROUND OF THE INVENTION

Infrastructure operators, as well as other organizations that collect fees related to vehicular traffic, often use particularized billing, which takes into account each cargo unit being transported. Sometimes, particularized billing is used in order to promote efficient use of their facilities. For example, it is theoretically possible for a highway operating authority to charge according to the cargo units' types, weights, values, and destinations. In doing so, the authority is able to promote policies, such as giving priority to cargo units that destined for disaster areas.

Such particularized billing, or charging, can be implemented if the cargo units are outfitted with sensors, radios, and the associated electronics, so that the highway operator can query about the destination, the value, and the state in general of each cargo unit. The inquiries can originate from a location that is near the cargo unit being transported or from a location that is thousands of miles away from the unit. In either case, a portable object that is capable of responding to an inquiry about itself, such as an outfitted cargo unit, is considered to be a “responsive object.”

Transforming cargo units into responsive objects in the prior art can further be used to implement a billing scheme where the owner of a cargo unit, as opposed to the truck operator, is charged directly the toll fees for transporting the cargo unit. If a responsive object is equipped with a storage device carrying the owner's account information, this information can be retrieved by the highway operating authority on demand, and toll fees can be charged directly to the owner of the responsive object. Such direct billing can result in a reduction of the accounting expenses of both the owner and the operator of the truck.

When a responsive object is located outside of a vehicle, is on land, and is stationary, the responsive object is usually able to successfully receive and respond to an inquiry, such as an electromagnetic signal that conveys a payment request. In contrast, when a responsive object is within a vehicle, far from land, or moving, the ability of the responsive object to successfully receive and respond to inquiries can be impeded, typically because the inquiry signal is significantly attenuated or distorted. Therefore, the need exists for an improvement in the ability to monitor, bill, and pay for responsive objects.

### SUMMARY OF THE INVENTION

Some embodiments of the present invention provide a mechanism for monitoring the state of responsive objects and for the billing and payment for those objects, without some of the costs and disadvantages of techniques in the prior art. For the purposes of this specification, a “responsive object,” and its inflected forms, is defined as a portable object, such as a cargo unit, that is capable of responding to an inquiry about itself, such as a payment request, having been outfitted with one or more sensors, a radio, and associated electronics.

In accordance with the illustrative embodiment, a transport vehicle that carries responsive objects, such as a truck that is hauling cargo units, is outfitted with a proxy that represents the responsive objects. The proxy is configured such that it is better able than the responsive objects to receive payment request signals from a querying device and is therefore able to represent those objects. The vehicle is also outfitted with i) one or more sensors that detect the responsive objects that the vehicle is carrying and ii) one or more sensors that detect state information of the vehicle. Both sets of sensors provide information to the proxy. In some embodiments, the responsive-object sensors are able to query each responsive object in the same way that the querying device queries those objects in the prior art. The state of the vehicle can comprise, but is not limited to, one or more of the vehicle's destination, its weight, and one or more environmental conditions inside and/or outside the vehicle such as temperature, humidity, and barometric pressure.

When it is within range of one or more payment request signals, such as being in the vicinity of a toll booth's querying device, the proxy of the illustrative embodiment detects each request and responds on behalf of one or more of the responsive objects by providing the state of the vehicle, account information for each responsive object, and/or payment amount attributed to that responsive object. In some embodiments, the responsive objects operate in accordance with different protocols, and the proxy is multi-lingual in the sense that it can communicate with each responsive object according to its protocol. In some embodiments, the proxy is also able to communicate with multiple querying devices in accordance with their individual protocols.

Furthermore, the proxy is capable of obtaining account information for a responsive object, as well as determining an amount to be paid from the account, by applying a pricing list in conjunction with the state of the vehicle (e.g., location, destination, condition, etc.), which can be used instead of the state of each individual object. In this way, the illustrative embodiment provides a mechanism for adjusting the payment amount according to a variety of parameters at the vehicle.

The illustrative embodiment comprises: a first responsive object that is capable of responding to a first payment request signal by providing a first account datum; a first sensor for detecting when the first responsive object is within a predetermined vehicle; a second sensor for sensing a state of the predetermined vehicle; and a proxy for responding to the first payment request signal when the first responsive object is detected as being within the predetermined vehicle, wherein the proxy responds to the first payment request signal based on the state of the predetermined vehicle and by providing the first account datum.

### BRIEF DESCRIPTION OF THE DRAWINGS

FIG. 1 depicts a schematic diagram of the salient components of payment system 100 in accordance with the illustrative embodiment of the present invention.

FIG. 2 depicts a flowchart of the salient tasks associated with the operation of the illustrative embodiment of the present invention.

FIG. 3 depicts a flowchart of the salient subtasks associated with the completion of task 207 depicted in FIG. 2.

### DETAILED DESCRIPTION

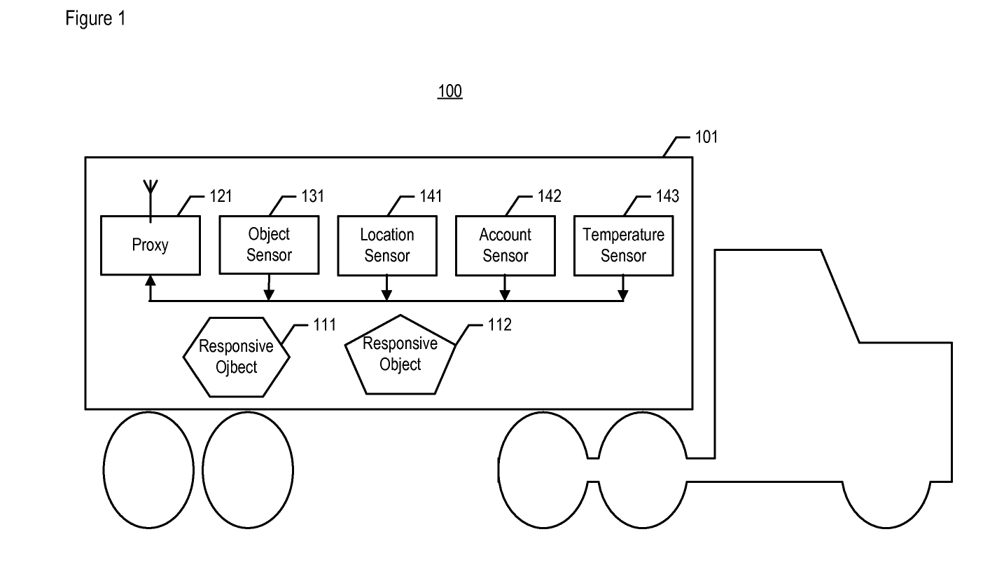

FIG. 1 depicts a schematic diagram of the salient components of payment system 100 in accordance with the illustrative embodiment of the present invention. Payment system 100 comprises: vehicle 101, responsive object 111, responsive object 112, proxy 121, responsive object sensor 131, location sensor 141, account sensor 142, and temperature sensor 143, interconnected as shown.

The illustrative embodiment as disclosed herein comprises certain features, yet many variations of what is disclosed are possible. First, in accordance with the illustrative embodiment, proxy 121 is within vehicle 101 (e.g., inside the trailer, etc.). However, it will be clear to those skilled in the art, after reading this disclosure, how to make and use alternative embodiments of the present invention in which proxy 121 is external to vehicle 101. For example, proxy 121 can serve multiple vehicles while either being attached to the outside of vehicle 101 or not being attached to vehicle 101 at all. Second, in accordance with the illustrative embodiment, vehicle 101 comprises two responsive objects, but it will be clear to those skilled in the art, after reading this disclosure, how to make and use alternative embodiments of the present invention that comprise any number of responsive objects. Third, in accordance with the illustrative embodiment, vehicle 101 comprises one temperature sensor, one location sensor, and one account sensor. However, it will be clear to those skilled in the art, after reading this disclosure, how to make and use alternative embodiments of the present invention that comprise any number of location sensors and account sensors, as well as any number and kind of environmental sensors, such as barometric sensors, light sensors, gravimetric sensors, and so forth.

Vehicle 101 is a truck for carrying responsive object 111 and responsive object 112. In accordance with the illustrative embodiment, vehicle 101 is a truck, but it will be clear to those skilled in the art, after reading this disclosure, how to make and use alternative embodiments of the present invention in which vehicle 101 is another type of transportation such as a ship, an airplane, a train, and so forth. In any case, it will be clear to those skilled in the art how to make and use vehicle 101.

Responsive object 111, as is known in the art, comprises one or more of the following:
(i) a payload (not shown);
(ii) a location sensor (not shown) for detecting the location of responsive object 111;
(iii) a temperature sensor (not shown) for detecting the ambient temperature in the proximity of responsive object 111;
(iv) a storage device for storing billing account information; and
(v) hardware and software (not shown) that is capable of responding to a payment request signal, where the response is based on the state of responsive object 111 as determined from information from the location sensor, the account sensor, and the temperature sensor.
   In accordance with the illustrative embodiment, the payment request is formatted in accordance with a first protocol. It will be clear to those skilled in the art how to make and use responsive object 111.

Similarly, responsive object 112, as is known in the art, comprises one or more of the following:
(i) a payload (not shown);
(ii) a location sensor (not shown) for detecting the location of responsive object 112;
(iii) a temperature sensor (not shown) for detecting the ambient temperature in the proximity of responsive object 112;
(iv) a storage device for storing billing account information; and
(v) hardware and software (not shown) that is capable of responding to a payment request signal, where the response is based on the state of responsive object 112 as determined from information from the location sensor, the account sensor, and the temperature sensor.

In accordance the illustrative embodiment, the payment request with respect to object 112 is formatted in accordance with a second protocol that is different from the first protocol. However, it will be clear to those skilled in the art, after reading this disclosure, how to make and use alternative embodiments of the present invention in which the first protocol and the second protocol are the same. In accordance with the illustrative embodiment, the hardware and software of responsive object 112 is the same as that of responsive object 111, but it will be clear to those skilled in the art, after reading this disclosure, how to make and use alternative embodiments of the present invention in which the hardware and software is different. In any event, it will be clear to those skilled in the art how to make and use responsive object 112.

Proxy 121 comprises hardware and software that detects and responds to payment request signals that otherwise would have been detected and responded to by responsive objects 111 and 112 under different circumstances. The proxy responds on behalf of those objects because they are unable or unwilling to respond to the inquiries themselves while inside vehicle 101. For example, electromagnetic signals transmitted by a querying device might be significantly attenuated or distorted by the time that they reach objects 111 and 112 inside the vehicle, such that the objects are incapable of responding to, or even detecting, the signals. Proxy 121 also receives input from responsive object sensor 131, location sensor 141, account sensor 142, and temperature sensor 143, which are described below. In accordance with the illustrative embodiment, proxy 121 is capable of responding to inquiries directed to responsive object 111 in accordance with the first protocol and to inquiries directed to responsive object 112 in accordance with the second protocol.

Responsive object sensor 131 comprises hardware and software for detecting the presence or absence of responsive object 111 within vehicle 101 and for detecting the presence or absence of responsive object 112 within vehicle 101. In accordance with the illustrative embodiment, responsive object sensor 131 comprises a single housing, but it will be clear to those skilled in the art how to make and use alternative embodiments of the present invention in which responsive object sensor 131 comprises multiple housings. Furthermore, in accordance with the illustrative embodiment, responsive object sensor 131 uses radio-frequency identification (“RFID”) technology in well-known fashion. However, it will be clear to those skilled in the art, after reading this disclosure, how to make and use alternative embodiments of the present invention in which responsive object sensor 131 uses something else such as, but not limited to, an optical bar code system. In accordance with the illustrative embodiment, responsive object sensor 131 is located within vehicle 101, but it will be clear to those skilled in the art, after reading this disclosure, how to make and use alternative embodiments of the present invention in which responsive object sensor 131 is located external to vehicle 101. It will be clear to those skilled in the art how to make and use responsive object sensor 131.

Location sensor 141 comprises a Global Positioning System receiver for detecting the geographic location of vehicle 101. Location sensor 141 acts as a substitute for the location sensors within responsive object 111 and responsive object 112. In accordance with the illustrative embodiment location sensor 141 is capable of detecting the latitude, longitude, and/or altitude of vehicle 101. Although location sensor 141 is a satellite positioning system receiver, it will be clear to those skilled in the art how to make and use alternative embodiments of the present invention in which location sensor 141 uses another technology such as, while not being limited to, network-based location systems based on triangulation and trilaterialization. It will be clear to those skilled in the art how to make and use location sensor 141.

Account sensor 142 comprises hardware and software for determining the account information, which comprises account data, of responsive object 111 and responsive object 112. In accordance with the illustrative embodiment, account sensor 142 is a wireless smart card reader, but it will be clear to those skilled in the art, after reading this disclosure, how to make alternative embodiments of the present invention in which account sensor 142 is a similar device such as, while not being limited to, a wireless point-of-sale terminal. Although account sensor 142 is depicted in FIG. 1 as comprising a single housing, it will be clear to those skilled in the art, after reading this disclosure, how to make and use alternative embodiments of the present invention in which account sensor 142 comprises a plurality of housings. Furthermore, it will be clear to those skilled in the art, after reading this disclosure, how to make and use alternative embodiments in which account sensor 142 comprises a connection to a centralized account database.

Temperature sensor 143 comprises hardware for measuring the temperature inside and/or external to vehicle 101. Temperature sensor 142 acts as a substitute for the temperature sensors within responsive object 111 and responsive object 112. Although temperature sensor 143 is depicted in FIG. 1 as comprising a single housing within vehicle 101, it will be clear to those skilled in the art, after reading this disclosure, how to make and use alternative embodiments of the present invention in which temperature sensor 143 is external to vehicle 101. Furthermore, it will be clear to those skilled in the art, after reading this disclosure, how to make and use alternative embodiments of the present invention in which temperature sensor 143 comprises a plurality of housings. And still furthermore, it will be clear to those skilled in the art, after reading this disclosure, how to make and use alternative embodiments of the present invention in which temperature sensor 143 comprises a connection to a weather reporting service such as http://www.weather.gov.

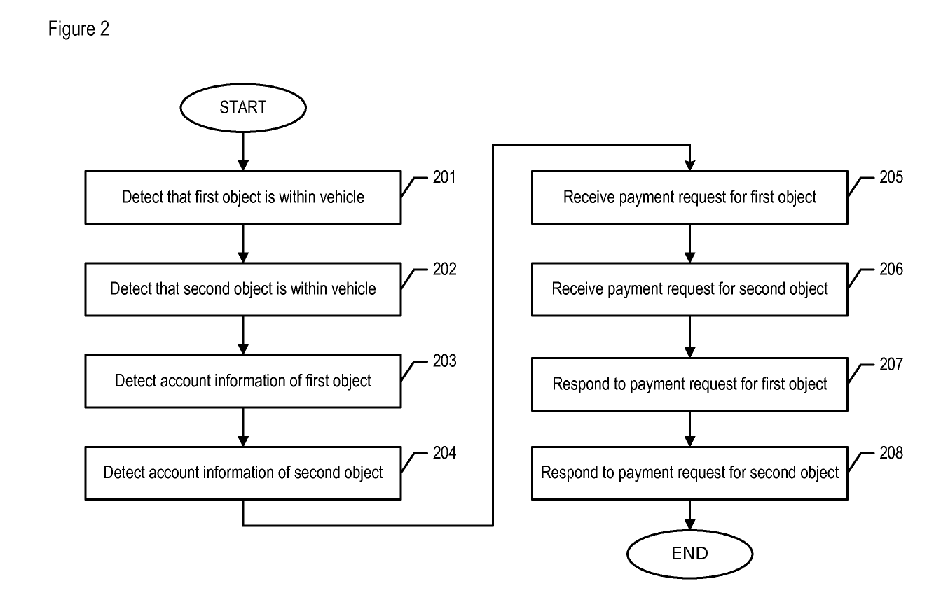

FIG. 2 depicts a flowchart of the salient tasks associated with the operation of the illustrative embodiment of the present invention.

At task 201, object sensor 131 detects the presence of responsive object 111 within vehicle 101. The detection might indicate that responsive object 111 is incapable of responding to inquiries, or the lack of capability might be determined through other means. It will be clear to those skilled in the art how to make and use embodiments of the present invention that accomplish task 201.

At task 202, object sensor 131 detects the presence of responsive object 112 inside vehicle 101. The detection might indicate that responsive object 112 is incapable of responding to inquiries, or the lack of capability might be determined through other means. It will be clear to those skilled in the art how to make and use embodiments of the present invention that accomplish task 202.

In accordance with the illustrative embodiment, tasks 201 and 202 are accomplished serially, but it will be clear to those skilled in the art how to make and use alternative embodiments of the present invention in which tasks 201 and 202 are performed simultaneously or concurrently.

At task 203, account sensor 142 detects the account information of first responsive object 111.

At task 204, account sensor 142 detects the account information of second responsive object 112. In accordance with the illustrative embodiment of the present invention, the protocol according to which the account information for first responsive object is formatted is different from the protocol in which the account information for the second responsive object is encoded. However, it will be clear to those skilled in the art, how to devise embodiments of the present invention in which the cooperating objects inside vehicle 101 use a uniform protocol for the encoding of their account information.

In accordance with the illustrative embodiment, tasks 203 and 204 are accomplished serially, but it will be clear to those skilled in the art how to make and use alternative embodiments of the present invention in which tasks 203 and 204 are performed simultaneously or concurrently.

At task 205, proxy 121 detects an inquiry signal that is transmitted with responsive objects in mind, such as responsive object 111, and in accordance with a first protocol. In accordance with the illustrative embodiment of the present invention, the inquiry is a payment request signal that is transmitted to proxy 121 via wireless telecommunications. In some alternative embodiments, the inquiry represents something other than a payment request.

At task 206, proxy 121 detects an inquiry signal that is transmitted with responsive objects in mind, such as responsive object 112, and in accordance with a second protocol. In accordance with the illustrative embodiment of the present invention, the inquiry is a payment request signal that is transmitted to proxy 121 via wireless telecommunications. In some alternative embodiments, the inquiry represents something other than a payment request.

In accordance with the illustrative embodiment, tasks 205 and 206 are accomplished serially, but it will be clear to those skilled in the art how to make and use alternative embodiments of the present invention in which tasks 205 and 206 are performed simultaneously or concurrently. Furthermore, as those who are skilled in the art will appreciate, the inquiry signals detected at tasks 205 and 206 might be separate signal transmissions entirely, different parts of the same continuous transmission, or the same part of the same continuous transmission.

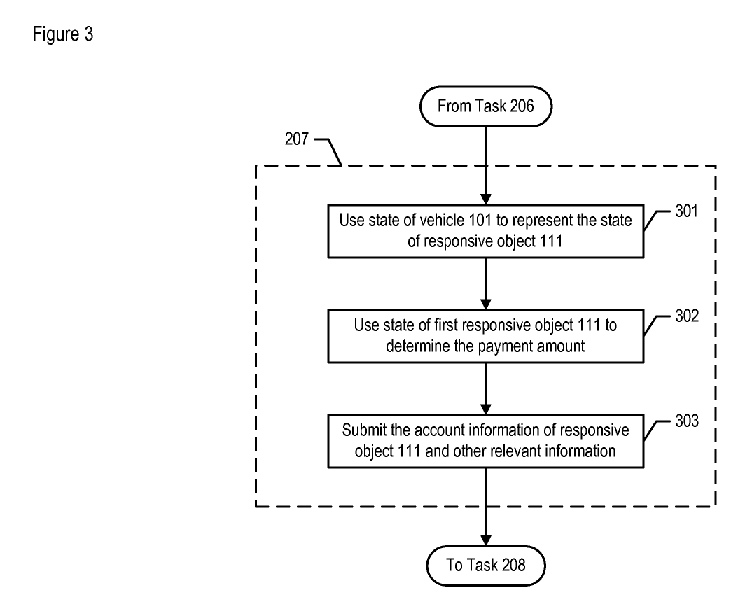

At task 207, proxy 121 responds to the inquiry for responsive object 111 in accordance with the first protocol. Task 207 comprises several sub-steps which are described in detail in the discussion concerning FIG. 3 below. In accordance with the illustrative embodiment, the operation of proxy 121 is invisible to the transmitter of the inquiry, but it will be clear to those skilled in the art, after reading this disclosure, how to make and use alternative embodiments of the present invention in which the operation of proxy 121 is made known to the transmitter of the inquiry.

At task 208, proxy 121 responds to the payment request signal for responsive object 112 in accordance with the second protocol. The performance of task 208 is analogous to the performance of task 207 and it is described more comprehensively in the discussion concerning FIG. 3 below. In accordance with the illustrative embodiment, the operation of proxy 121 is invisible to transmitter of the inquiry, but it will be clear to those skilled in the art, after reading this disclosure, how to make and use alternative embodiments of the present invention in which the operation of proxy 121 is made known to the transmitter of the inquiry.

In accordance with the illustrative embodiment, tasks 205 and 206 are accomplished serially, but it will be clear to those skilled in the art how to make and use alternative embodiments of the present invention in which tasks 207 and 208 are performed simultaneously or concurrently.

FIG. 3 depicts a flowchart of the salient subtasks associated with the execution of task 207.

At task 301, proxy 121 estimates the state of the object from the state of the vehicle. For example, if the inquiry to responsive object 111 requests the temperature of responsive object 111 or necessitates that a temperature be obtained in order to determine the state, proxy 121 obtains the temperature of vehicle 101, as measured by temperature sensor 143. As another example, if the inquiry to responsive object 111 requests the location of responsive object 111 or necessitates that a location be obtained in order to determine the state, proxy 121 obtains the location of vehicle 101, as measured by location sensor 141.

At task 302, proxy 121 determines the amount of payment attributed to responsive object 111 (i.e., the amount owed) by considering the state of object 111, which is estimated as described with respect to task 301 or otherwise obtained. In accordance with the illustrative embodiment of the present invention, proxy 121 uses only the state of responsive object 111 as a factor in estimating the amount owed, but it will be clear to those skilled in the art, after reading this disclosure, how to devise alternative embodiments that consider additional factors such as, while not being limited to, a payment schedule that indicates when a payment is due, a pricing list that indicates how much is due for each object, and so forth.

In some other alternative embodiments, proxy 121 determines the amount of payment attributed to object 111 based on whether one or more other objects are present, such as object 121. For example, proxy 121 might factor in a discount when more than one object is present.

At task 303, proxy 121 submits, to the transmitter of the payment request signal, a message with i) the amount of payment attributed to responsive object 111 and ii) its account information. In accordance with the illustrative embodiment, proxy 121 submits the account information and the amount owed. However, it will be clear to those skilled in the art, after reading this disclosure, how to devise alternative embodiments of the present invention where proxy 121 submits only the amount owed or only the account information. In addition, it will be clear to those skilled in the art how to devise alternative embodiments of the present invention where additional information is submitted in the response to the payment request signal such as, while not being limited to, authentication information.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A system comprising:
a first responsive object that is capable of responding to a first payment request signal by providing a first account datum;
a first sensor for detecting when the first responsive object is within a predetermined vehicle;
a second sensor for sensing a state of the predetermined vehicle; and
a proxy for responding to the first payment request signal when the first responsive object is detected as being within the predetermined vehicle, wherein the proxy responds to the first payment request signal based on the state of the predetermined vehicle and by providing the first account datum.

2. The system of claim 1 further comprising a second responsive object that is capable of responding to a second payment request signal by providing a second account datum;
wherein the proxy is also for responding to the second payment request signal; and
wherein the proxy responds to the second payment request signal based on the state of the predetermined vehicle and by providing the second account datum.

3. The system of claim 1 wherein the value of the first account datum is based on the state of the predetermined vehicle.

4. The system of claim 1 wherein the proxy is also for determining an amount owed for the first responsive object according to i) the state of the predetermined vehicle and ii) a pricing list.

5. The system of claim 1 wherein the proxy is also for determining an amount owed for the first responsive object according to i) the state of the predetermined vehicle and ii) a payment schedule.

6. The system of claim 1 wherein the proxy serves the predetermined vehicle only.

7. The system of claim 1 wherein the proxy serves multiple vehicles, including the predetermined vehicle.

8. A system comprising:
a first responsive object that is capable of responding to a first payment request signal;
a first sensor for detecting when the first responsive object and a second responsive object are within a predetermined vehicle; and
a proxy for responding to the first payment request signal when the first responsive object is detected as being within the predetermined vehicle, wherein the proxy responds to the first payment request signal based on the presence of the second responsive object.

9. The system of claim 8 wherein the proxy also responds to the first payment request signal by providing a first account datum, the value of which being based on the presence of the second responsive object.

10. The system in claim 8 further comprising a second sensor for sensing a state of the predetermined vehicle;
wherein the proxy also responds to the first payment request signal based on the state of the predetermined vehicle.

11. The system of claim 8 wherein the second responsive object is capable of responding to a second payment request signal, and
wherein the proxy is also for responding to the second payment request signal.

12. The system of claim 11 wherein the proxy is also for responding to the second payment request signal based on the presence of the first responsive object.

13. The system of claim 8 wherein the proxy is also for determining an amount owed for the first responsive object according to a pricing list.

14. The system of claim 8 wherein the proxy is also for determining an amount owed for the first responsive object according to a payment schedule.

15. The system of claim 8 wherein the proxy serves the predetermined vehicle only.

16. The system of claim 8 wherein the proxy serves multiple vehicles, including the predetermined vehicle.

17. A system comprising:
a first responsive object that is capable of responding to a first payment request signal;
a second responsive object that is capable of responding to a second payment request signal;
a first sensor for detecting when the first responsive object and the second responsive object are within a predetermined vehicle; and
a proxy for responding to at least one of the first payment request signal and the second payment request signal when the first responsive object and the second responsive object are detected as being within the predetermined vehicle, wherein the proxy responds based on the presence of both the first responsive object and the second responsive object.

18. The system in claim 17 further comprising a second sensor for sensing a state of the predetermined vehicle;
wherein the proxy also responds based on the state of the predetermined vehicle.

19. The system of claim 17 wherein the proxy serves the predetermined vehicle only.

20. The system of claim 17 wherein the proxy serves multiple vehicles, including the predetermined vehicle.
